(19) United States
(12) Patent Application Publication
(10) Pub. No.: US 2012/0031176 A1
(43) Pub. Date: Feb. 9, 2012

(54) SAMPLE STORAGE IN MICROFLUIDICS DEVICES

(76) Inventors: Kris Naessens, Melle (BE); Tony Montoye, Drongen (BE); Ronny Bockstaele, Merelbeke (BE); Bert Luyssaert, Gent (BE)

(21) Appl. No.: 13/262,686

(22) PCT Filed: Apr. 6, 2010
(86) PCT No.: PCT/EP2010/054558

§ 371 Date: Oct. 3, 2011

(30) Foreign Application Priority Data
Apr. 6, 2009 (EP) PCT/EP2009/054107

(51) Int. Cl. G01N 1/00; G01N 30/00; B01L 3/00

(52) U.S. Cl. 73/61.59; 422/507; 422/69

(57) ABSTRACT

The present invention relates to a microfluidics device (100) for characterising microfluidic samples. The microfluidics device (100) comprises at least one input well (110) for receiving an amount of liquid to be characterized in the microfluidics device (100) and a storage chamber (140) for storing the liquid, prior to said characterization. The microfluidics device (100) thereby is adapted for, upon receipt of the amount of liquid in the input well (110), spontaneously transferring substantially all of said amount of liquid to said storage chamber (140).

### FIELD OF THE INVENTION

The invention relates to the field of microfluidics characterisation. More particularly the present invention relates to methods and devices for characterisation of microliter amounts of fluids.

### BACKGROUND OF THE INVENTION

Characterisation of microfluidics is used in a wide variety of applications, such as for example in the field of biology, biotechnology, chemistry and for clinical and medical purposes. One of the requirements posed in the majority of these applications is the need for high accuracy of the analysis. Also, characterisation is often hampered by the limited amount of sample that is available.

One of the sources of inaccuracy when performing characterisation of microfluidics, especially when quantitative concentration determination is envisaged, is the occurrence of evaporation of the sample between the initial introduction of the sample in the test device and the actual measurement. One example of a known technique for determining concentration of a component in a microfluidic sample using optical absorption measurements, e.g. for determining the concentration of DNA molecules in a microliter DNA suspension, is as follows: a microfluidic sample is provided in an input well. Some time later, for example depending on the experience of the operator and/or the number of channels used in the characterisation device, the liquid is transported to a measurement chamber for performing the optical absorption measurement. Concentration is then determined based on the specific absorption of an irradiation beam by the sample. In the period prior to the measurement, evaporation of sample components takes place as long as the DNA suspension is in contact with the ambient air. Such an evaporation results in a decrease of the absolute amount of solvent or buffer in the DNA suspension, resulting in an increase of the measured concentration of DNA molecules. Such evaporation therefore may compromise the accuracy of the analysis, and assessment of the initial concentration is virtually impossible. FIG. 1 illustrates an example of evaporation of different volumes of samples dispensed in different input wells. It can be seen that the volume drops significantly in a time range of a couple of minutes, which is typically the time that may lapse between initial introduction of the sample in the test device and the moment of actual measurement. The effect on the quantitative results obtained based thereon as function of the time lapsed between initial introduction of the sample in the test device and the moment of actual measurement is shown in FIG. 2 for the 1.5 μl sample and for the 2 μl sample in one type of input well. It can be seen that the accuracy of the results obtained is significantly influenced by evaporation of the sample. Another disadvantage of evaporation of the sample is the reduction of the volume of the sample. As typically a minimal amount of sample is required to perform the measurement, evaporation results in a larger volume to be dispensed in order to be able to perform the measurements some time afterwards and thus in an increased use of sample. It will be clear for the skilled person that, as evaporation occurs independent of the amount of sample available, the problem becomes especially relevant when microliter samples need to be analysed. For small sample volumes, this may result in not sufficient sample being available for measurement.

One solution to at least partly counter evaporation is provided in European patent EP1255610, describing a covered microfluidic device wherein a lid cover is provided to cover the microchannel structures for minimising or preventing undesired evaporation of liquids. A further source of inaccuracy during characterisation of microfluidics can be found in improper introduction of sample in the characterisation device. Systems are known, e.g. from US application 2002/0114738 A1, wherein introduction of fluid in the system is performed by pressing the tip of a pipette tightly into a funnel shaped inlet port and injecting fluid in a filling chamber. These particular shapes of the inlet port may nevertheless prevent automated sample provision, especially when automated simultaneous sample introduction is envisaged in a multichannel characterisation device. For example, small variations in the distance between different channels in a multichannel pipetting device or between the multichannel characterisation device may lead to inaccurate positioning of the pipette positions with respect to the inlet ports, resulting in inaccurate introduction of the sample in the different channels and e.g. spilling of the sample. But even for single channel dispensing there is a limited accuracy in the positioning of the dispensing tip with respect to the inlet port due to the instrumental positioning accuracy of the tip and the manufacturing tolerances of the microfluidic device. In addition, tip release from the inlet port after it has been pressed into it, can lead to loss of the tip (in case of disposable tips) or displacement of the microfluidic device.

### SUMMARY OF THE INVENTION

It is an object of embodiments of the present invention to provide good devices and methods for characterizing microliter amounts of fluids or assisting therein. It is an advantage of embodiments according to the present invention that a good or improved accuracy can be obtained in the characterisation of microliter samples.

The above objective is accomplished by a method and device according to the present invention.

The present invention relates to a microfluidics device comprising at least one input well for receiving an amount of liquid to be characterised in the microfluidics device and a storage chamber for, prior to said characterisation, storing the liquid e.g. as inserted in the input well, wherein the microfluidics device is adapted for, upon receipt of the amount of liquid in the input well, spontaneously transferring substantially all of said amount of liquid to said storage chamber. It is an advantage of embodiments of the present invention that substantially the complete fluid is removed automatically and quickly from the input well to the storage chamber, thus reducing and/or avoiding e.g. uncontrollable evaporation of liquids. Avoidance of uncontrollable evaporation of the liquid results in a better accuracy of the characterisation performed. It is an advantage of some embodiments according to the present invention that such reduction and/or control can be obtained without hampering an automated filling process, even for automated simultaneous filling in a multi-channel system. It is an advantage of embodiments according to the present invention that evaporation can be reduced, resulting in more accurate results, especially in the case of small sample volumes.

The present invention also relates to a microfluidics device comprising at least one input well for receiving an amount of liquid to be characterized in the microfluidics device, a storage chamber for storing, prior to said characterisation, the liquid, and a measurement chamber for receiving said liquid from said storage chamber at a later time for characterization, after said storing, wherein the storage chamber is a capillary chamber and has a volume adapted for, upon receipt of the amount of liquid in the input well, spontaneously transferring through capillary force substantially all of said amount of liquid to said storage chamber, the storage chamber being shaped so that, directly after filling the storage chamber, the interface area of the liquid with ambient gas in the storage chamber is smaller than the interface area of liquid with ambient gas in the input well.

The present invention also relates to a method for characterising a microfluidic sample, the method comprising receiving an amount of liquid to be characterised in the microfluidics device and spontaneously transferring substantially all of said amount of liquid to a storage room for storing the liquid prior to the characterisation.

The present invention furthermore relates to a characterisation system for characterising microfluidic samples comprising a microfluidic structure as described above.

Particular and advantageous aspects of some embodiments of the invention are set out in the accompanying dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter. Embodiments of the present invention lead to improved characterisation of microfluidics.

### BRIEF DESCRIPTION OF THE DRAWINGS

FIG. 1 and FIG. 2 illustrate the effect of evaporation on the volume of a sample and on the determined concentration of a component in a sample respectively as function of time lapsed between initial introduction and measurement of the sample, illustrating a problem that can be solved by embodiments of the present invention.

FIG. 3 and FIG. 4 illustrate a cross-section and side view of a microfluidic device with spontaneous filling of a storage chamber upon filling of the input well, according to an embodiment of the present invention.

FIG. 5A to FIG. 5G illustrate different ways for introducing a microfluidic sample in an input well of a microfluidic device according to an embodiment of the present invention.

FIG. 6 illustrates two possible shapes of an input well as may be used according to embodiments of the present invention, whereby the bottom surface is formed by the throughput opening to the storage chamber (A) or whereby a small surface is surrounding the throughput opening to the storage chamber, the ensemble forming the bottom surface (B).

FIG. 7A to FIG. 7C illustrates a number of cornered shapes for a throughput hole as can be used in a microfluidic device according to an embodiment of the present invention.

FIG. 8 illustrate a snake-like shape of a storage chamber as can be used in a microfluidic device according to an embodiment of the present invention.

FIG, 9A to FIG. 9i shows different configurations for a microfluidic device according to embodiments of the present invention.

FIG. 10 illustrates an exemplary method for characterising a microfluidic sample or assisting therein, as can be performed according to an embodiment of the present invention.

FIG. 11A to FIG. 11C illustrate the measured concentration and the amount of evaporation as function of residence time for dsDNA in a hydrophilic coated device, illustrating features and advantages of embodiments of the present invention.

FIG. 12A to FIG. 12C illustrate the measured concentration and the amount of evaporation as function of residence time for dNTP in a hydrophilic coated device, illustrating features and advantages of embodiments of the present invention.

FIG. 13A to FIG. 13C illustrate the measured concentration and the amount of evaporation as function of residence time for BSA in a hydrophobic device illustrating features and advantages of embodiments of the present invention.

FIG. 14A to FIG. 14C illustrate the measured concentration and the amount of evaporation as function of residence time for dsDNA in a hydrophobic device illustrating features and advantages of embodiments of the present invention.

FIG. 15A to FIG. 15C illustrate the measured concentration as function of the residence time in the input well, illustrating problems as can be at least partly solved by embodiments according to the present invention.

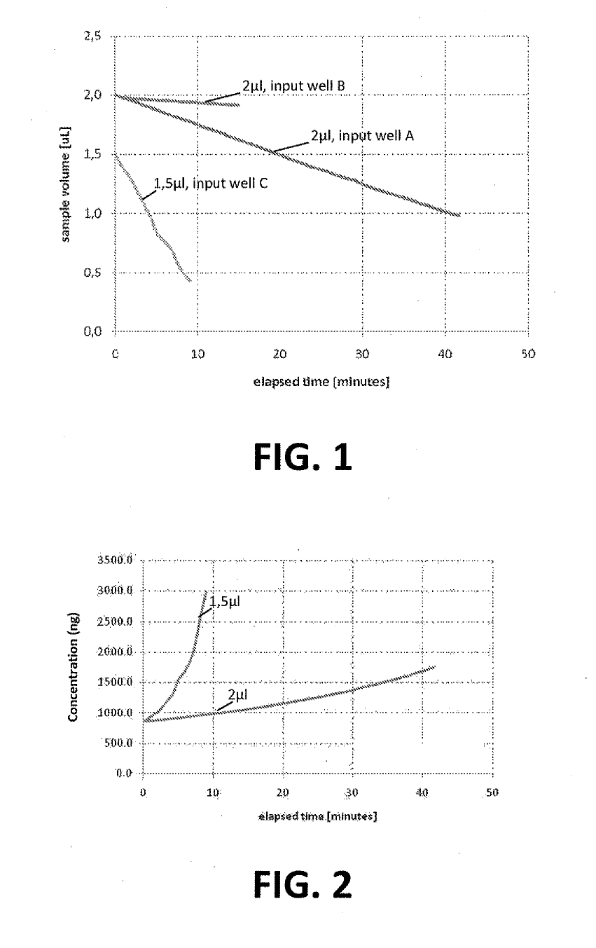

The drawings are only schematic and are non-limiting. In the drawings, the size of some of the elements may be exaggerated and not drawn on scale for illustrative purposes. Any reference signs in the claims shall not be construed as limiting the scope. In the different drawings, the same reference signs refer to the same or analogous elements.

### DETAILED DESCRIPTION OF ILLUSTRATIVE EMBODIMENTS

While the invention will be illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single unit may fulfill the functions of several items recited in the claims. The foregoing description details certain embodiments of the invention. It will be appreciated, however, that no matter how detailed the foregoing appears in text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

Where in embodiments according to the present invention reference is made to an interface liquid/ambient air, the latter may refer to the meniscus defining the edge between liquid and ambient air.

Where in embodiments according to the present invention reference is made to “directly after filling the storage chamber”, reference is made to instantaneously after filling the storage chamber. The latter also may be referred to as the moment directly after the spontaneous transfer from the input well to the storage chamber has occurred or as soon as the spontaneous transfer from the input well to the storage chamber has occurred or as soon as the storage chamber has been filled.

Where in embodiments according to the present invention reference is made to substantially all liquid, reference is made to all liquid, except for e.g. a small part of the fluid e.g. sticking to the walls of the input well. Such a small part may for example be less than 20%, advantageously less than 10%, more advantageously less than 5%.

In a first aspect, the present invention relates to a microfluidics device for characterising microfluidics. Embodiments of the present invention are especially suitable for characterisation of microfluidic samples of which only a small volume is available. The embodiments may be especially suitable for sample volumes between 0.2 μl and 7 μl, advantageously between 1 μl and 5 μl, more advantageously between 1 μl and 3.5 μl. Characterisation of microfluidic samples may comprise detection of the presence of certain components, determination of concentration of certain components, determination of certain reactions occurring, etc. Such characterisation may include for example applications in the field of biology, biotechnology, chemistry, the clinical field and/or the medical field. The microfluidic device according to embodiments of the present invention comprises an input well for receiving an amount of liquid to be characterised and a storage chamber for storing, prior to the characterisation, the liquid. The liquid may be stored as it was inserted in the input well. In embodiments of the present invention, the microfluidic device thereby is adapted for, upon receipt of the amount of liquid in the input well, spontaneously transferring substantially all of said amount of liquid to the storage chamber. With transferring substantially all of the amount of liquid, there is meant at least 80% of the liquid received in the input well, more advantageously at least 90% of the liquid received in the input well, still more advantageously at least 95% of the liquid received in the input well. Spontaneous thereby is defined as of its own motion, e.g. under gravity force or more advantageously via capillary forces, i.e. without the need for forces induced by an external source. According to embodiments of the present invention, “upon receipt of the amount of liquid in the input well” means that such spontaneous transfer may occur within a time span sufficiently short so that substantially no evaporation has occurred in the input well, e.g. a time span with an upper limit of 120 seconds from the moment the liquid is introduced in the input well, or more advantageously a timespan with an upper limit of 60 seconds from the moment the liquid is introduced in the input well, still more advantageously a timespan with an upper limit of 30 seconds from the moment the liquid is introduced in the input well.

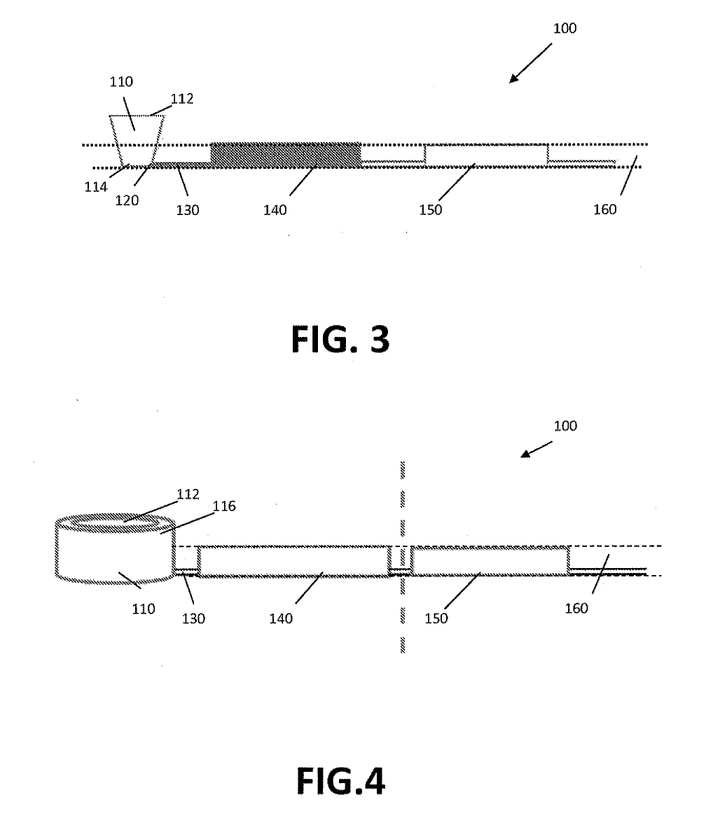

The microfluidic device may be a multichannel device, comprising a plurality of channels in which characterisation can be performed independently. The microfluidic device may for example comprise at least 8 channels, at least 16 channels, at least 32 channels, at least 96 channels or at least 384 channels. Further aspects and advantages will further be described with reference to FIG. 3 and FIG. 4, indicating standard and optional components of an exemplary microfluidic device according to embodiments of the present invention. FIG. 3 illustrates a schematic representation of a microfluidic device in cross-section, whereas FIG. 4 illustrates a schematic representation of a microfluidic device in side view.

As indicated above, the microfluidic device 100 comprises at least one input well 110. The volume of the input well 110 may be selected so that it can receive the sample volume to be measured, without the sample expelling over the edges of the input well 110. The surface area of the top surface 112 (also referred to as receiving surface) and the bottom surface 114 of the input well 110 may be determined by the available space on the microfluidic device 100. The available space may be limited as also the storage chamber 140, the measurement chamber 150, interconnection channels such as the throughput channel 130 connecting the input well 110 and the storage chamber 140, a throughput opening 120 and alignment holes require space on the device 100. The available space is of course even more limited in multi-channel characterisation devices 100, as the overall size of the characterisation device 100 will be limited, preferably adapted to conventional sizes such as defined in the microtiter plate standard. In one example, the available space per channel is between 10 and 100 mm². In embodiments according to the present invention, the receiving surface 112 of the input well 110, i.e. the receiving opening, is significantly larger than the average tip of a fluid introduction means, e.g. a pipette, used in microfluidics for introducing liquid, so that variation of the tip in size or position does not hamper accurate introduction of the liquid in the input well 110. In some embodiments according to the present invention, the input well 110 comprises upstanding walls 116 extending above a plate-shaped portion 160 of the microfluidics device 100 comprising the storage chamber 140, measurement chamber 150 and interconnection channels 130. The upstanding walls may extend e.g. between 0.2 mm and 50 mm above the plate-shaped portion. It is an advantage of such embodiments that the input well 110 is clearly visible for the user and/or that—in a multi-channel system—the upstanding walls 116 form a physical barrier for avoiding cross-contamination between neighbouring channels. Upstanding walls 116 extending above the plate-shaped portion 160 also have the advantage that the volume of the input well 110 can be selected significantly large while the input well 110 still has a limited footprint. It is furthermore an advantage of upstanding walls 116 extending above the plate-shaped portion 160 that these walls 116 can be used for releasing the liquid from the pipette tip. Upstanding walls also may lead to less convection of ambient air above the inlet port and thus lower evaporation.

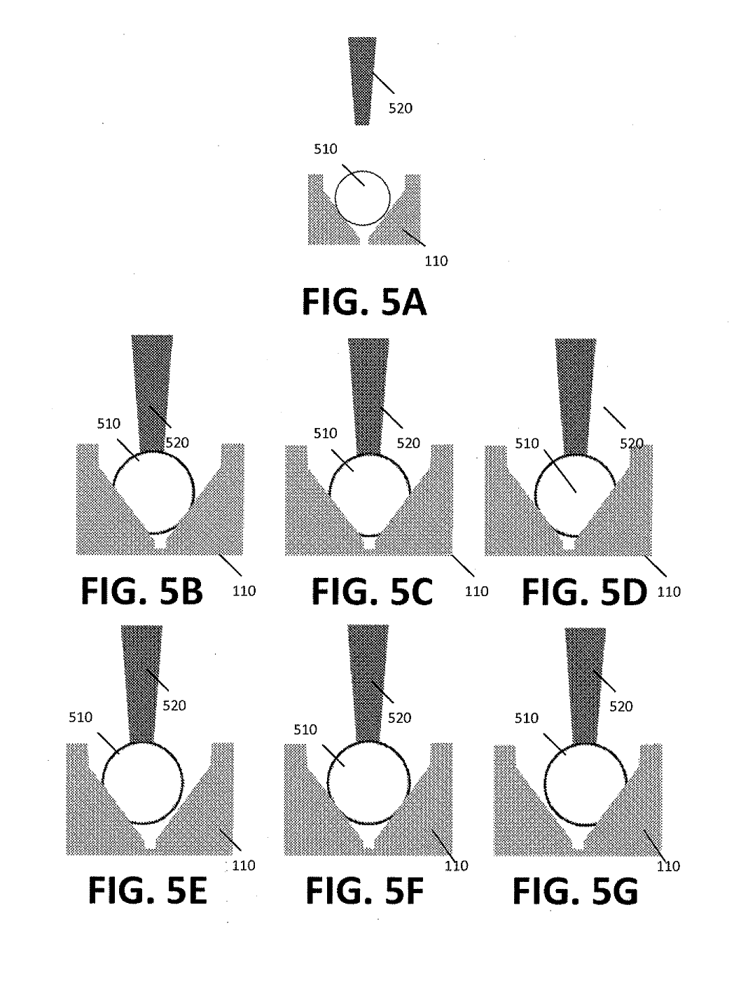

By way of illustration, a number of examples for dispensing of a drop of liquid 510 to be characterised in the input well 110 using a liquid dispensing means 520 like a pipette are illustrated in FIG. 5A to FIG. 5G. The dispensed liquid may make contact with one or both of the upstanding walls, or bottom and may be either centered above the throughput hole or not centered with respect thereto.

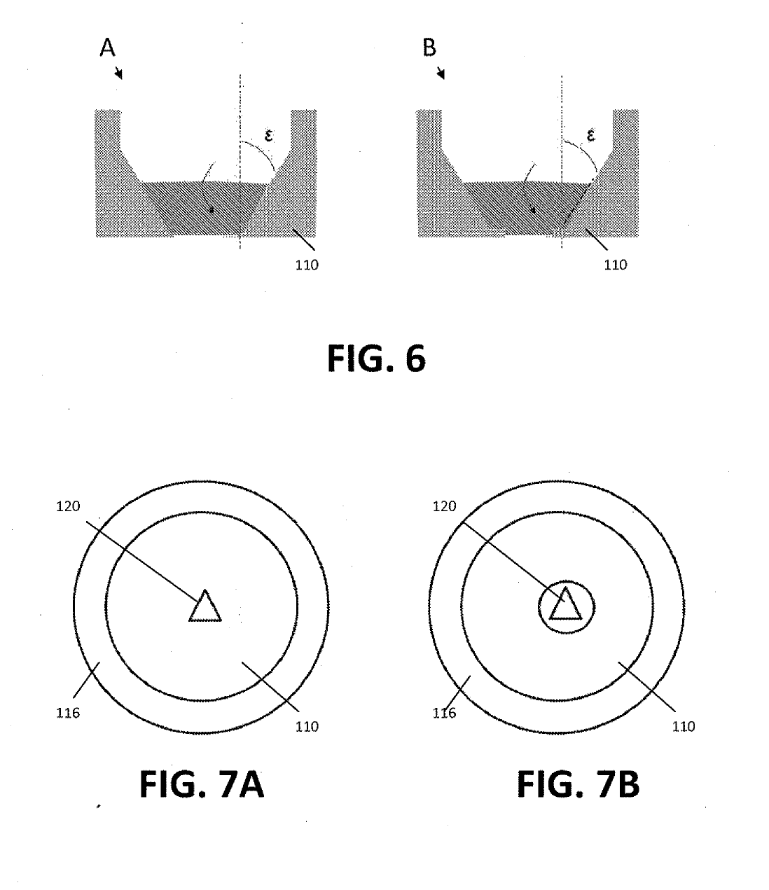

The shape of the input well 110 is selected so that the capillary upward forces on the liquid in the input well 110 and/or the pinning of the liquid in the input well 110 around the throughput opening 120 to the storage chamber 140, hindering the fluid from transferring to the storage chamber 140, are reduced. By way of example, FIG. 6 illustrates cross-sections of two possible shapes for such an input well, i.e. an input well whereby the bottom surface of the input well 110 is reduced to the throughput opening 120 towards the storage chamber (FIG. 6A) and an input well 110 having a small surface surrounding the throughput opening to the storage chamber (FIG. 6B), whereby the surrounding surface area is advantageously smaller than 50% of the receiving opening of the input well, more advantageously smaller than 35% of the receiving opening of the input well and still more advantageously smaller than 20% of the receiving opening 112 of the input well 110. Upon pinning at the throughput opening 120 in the surrounding surface area, only a small portion of the liquid will not be transferred, leaving only a small film on the upstanding walls of the input well after the remaining liquid has been transferred to the storage chamber 140. Alternatively, the throughput opening 120 also may be provided at the bottom of a side wall.

In advantageous embodiments the throughput opening 120 and throughput channel 130, if present, may be hydrophilic.

The portion of sample liquid left in the input well 110 after transfer to the storage chamber 140 is significantly small so that still substantially all of the liquid is transferred to the storage chamber. The upstanding walls 116, or at least a part of the upstanding walls closest to the bottom surface, advantageously are tilted with respect to the bottom 114 or the receiving surface 112 of the input well 110 so that capillary forces counteracting the transfer of the liquid to the storage chamber 140 are small, i.e. at least smaller than the pulling force in the capillary storage chamber. In one example, at least part of the upstanding walls 116 makes an angle ε of at least 20°, advantageously at least 30°, more advantageously at least 40° with the normal to the bottom surface. The input well 110 may at least partly have a conical shape. The inner surfaces of the input well 110 advantageously may be made as smooth as possible, in order to prevent pinning of the liquid. The production process of the microfluidic device 100, e.g. spray casting using different malls, may introduce burrs which may be the source of unwanted pinning of the fluid in the device. Such burrs may be removed by mechanical drilling, punching, laser ablation, etc. Furthermore, also during the production process measures may be taken to reduce the effect of burrs on pinning, e.g. by selecting different portions of the device to be formed by different malls, resulting in the burrs occurring in a different direction. In one embodiment, the walls 116 of the input well 110 also may be provided with grooves so that small air bubbles can be avoided in the throughput channel, if present, and the storage chamber 140.

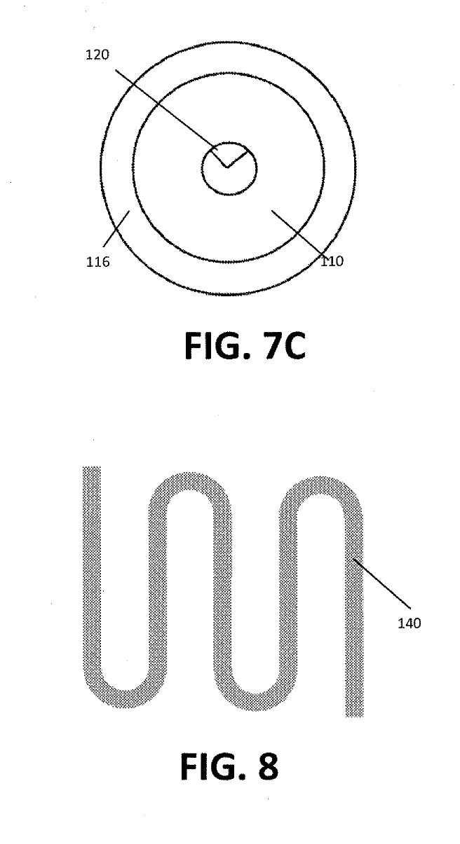

In order to prevent pinning at the throughput opening 120 in the input well 110, the throughput opening 120 may have a cornered shape such as a polygonal shape. By way of illustration, a number of cornered shapes for the throughput opening 120 are illustrated in FIG. 7A to FIG. 7C indicating a top view of the throughput opening 120 being the start portion of the throughput channel 130. An advantage of providing such structures thus is the increase of capillary forces on the liquid. FIG. 7A illustrates an input well whereby the throughput opening has a triangular shape. FIG. 7B illustrates a similar input well whereby the bottom of the throughput channel near the throughput opening has a triangular cornered shape for avoiding pinning. FIG. 7C shows a similar cornered shape as in FIG. 7B but not centered on the throughput opening 120.

One or more of the above described properties further may assist in leaving none or only small amounts of liquid in the input well and thus further may reduce the possibility of evaporation of the liquid provided in the input well and may lead to improved accuracy.

The microfluidic device 100 also comprises a storage chamber 140. The storage chamber 140 may be positioned between the input well 110 and a measurement chamber 150. It may be connected to the input well 110 via a throughput opening 120 and a throughput channel 130. The throughput channel, if present, also may be considered as part of the storage chamber 140. The storage chamber 140 may have a volume adapted for receiving substantially the full amount of sample received in the input well 110. The latter allows that, upon filling of the storage chamber 140, substantially no fluid remains in the input well 110, so that the problem of evaporation thereby is reduced. In one embodiment, the volume of the storage chamber 140 thus may correspond with at least the volume of the input well 110. In some examples, the volume of the storage chamber 140 may be between 0.2 μl and 7 μl. In one particular embodiment, the storage chamber 140 may have a minimum capacity of 3.5 μl. The storage chamber 140 furthermore advantageously may be adapted in shape so that after transfer of the liquid to the storage chamber, the free interface between the liquid and ambient air (upstream) in the storage chamber 140 is substantially smaller than the corresponding interface in the input well 110. In other words, the free surface at which evaporation can occur directly after transfer of the liquid to the storage chamber 140 advantageously is substantially smaller than for the liquid in the input well 110 so that evaporation can be significantly reduced.

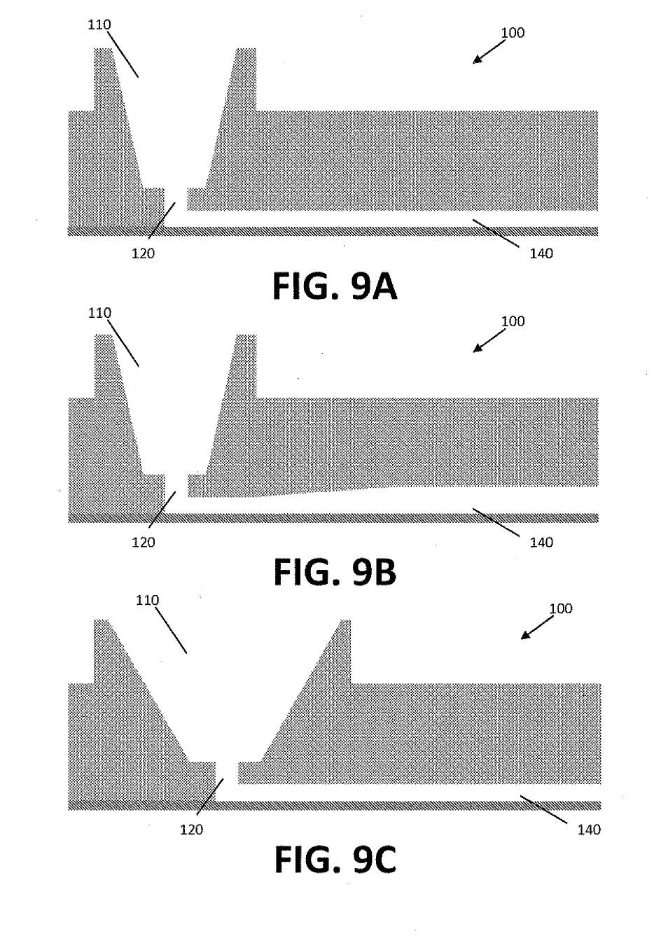

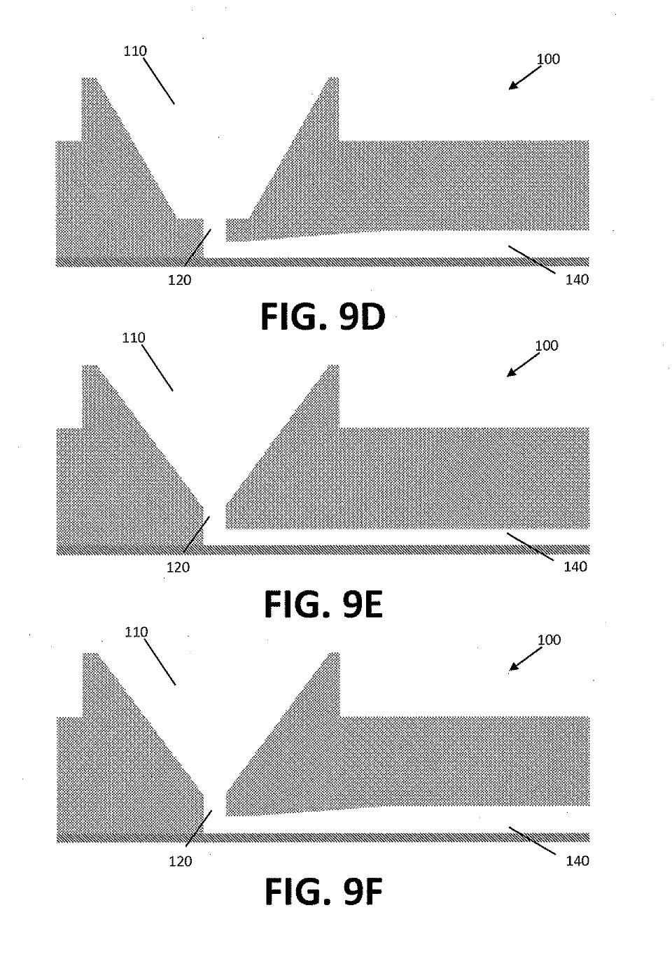

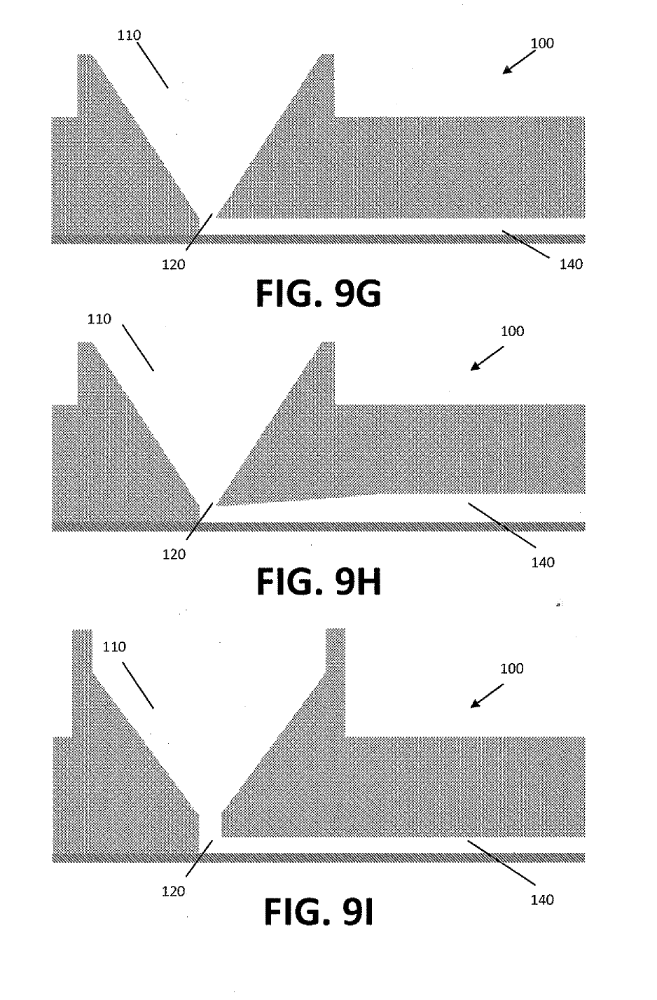

According to embodiments of the present invention, the microfluidic device 100 also is adapted so that spontaneous transfer of substantially all of the liquid sample provided in the input well 110 occurs to the storage chamber 140. In one embodiment, for obtaining quick and spontaneous transfer, the shape of the storage chamber 140 is adapted so that a large capillarity effect occurs pulling the sample liquid from the input well 110 to the storage chamber 140. As capillarity is higher for chambers having a large ratio of circumference to cross-section for contact angles smaller than 90° between the fluid meniscus and the wall, the storage chamber 140 may be selected to be small and long. By inducing strong capillarity, the spontaneous filling of the storage chamber 140 may be very liable, such that spontaneous fluid flow is not obstructed by dust particles or small rough features in the storage chamber. Selection of the cross-section of the storage chamber 140 may be performed, taking into account the available space, the minimal volume required, the design and the capillary forces required. The cross-section of the storage chamber may vary along the length of the storage chamber 140. By way of illustration, an exemplary top view of a design for a storage room 140 is shown in FIG. 8. By providing a snake like design, the required space for the storage chamber 140 can be significantly small and fit e.g. a 96 or 384 channel microfluidic device according to the microtiterplate standard. In one embodiment, a fixed cross-section over the full length of the storage chamber 140 is preferred, whereas in other embodiments, it may be preferred to have a storage chamber 140 wherein the cross-section reduces at positions in the storage chamber 140 further away from the input well 110. In one example, the storage chamber 140 has a cross section of 0.2 mm by 0.4 mm and a length of 44 mm, resulting in a storage capacity of about 3.5 μl. The walls of the channel may be slightly sloped in order to easily remove the device after moulding.

In one embodiment, for obtaining capillary forces, the walls or some of the walls of the input well 110, the storage chamber 140 and the throughput channel 130 may be hydrophilised. Applying a hydrophilic coating assists in obtaining a contact angle smaller than 90°. In some embodiments, the hydrophilic coating may be selected so that a contact angle between 80° and 0 is obtained. Other coatings also may be applied. Additional features for supplementary control of the flow, such as for example anti-wicking structures, also may be used. The application of the hydrophilic coating may be spatially limited. The hydrophilic coating may only be applied to the input well 110, the storage chamber 140 and the connection 120, 130 between the input well and the storage chamber. Examples of techniques for applying a hydrophilic coating are vacuum plasma coating whereby particles from an ionized suitable mixture of gas or atmospheric plasma coating whereby through flow particles of a plasma torch are moved towards the surface to be treated. By controlling the amount of movement, the portions of the microfluidic structure for which deposition is performed can be selected. Wet chemical coating is another example of a method for applying a hydrophilic coating, whereby a chemical substance is introduced in the microfluidic structure and whereby after drying a hydrophilic coating remains present at the walls of the microfluidic structure 100. The hydrophilic coating may be provided according to a predetermined pattern. The hydrophilic coating does not need to be constant over the walls of the storage chamber. As in some applications, the spatial distribution of the deposition of the hydrophilic coating may be difficult to control, the storage chamber may be slightly oversized so that the spatial distribution of the application of the hydrophilic coating becomes less sensitive. It is an advantage of methods whereby local application of a hydrophilic coating is applied, that unwanted condensation, e.g. on windows in a measurement chamber, can be reduced or avoided. The presence of a hydrophilic coating in the storage chamber 140 has as major advantage in that it further assists in the spontaneous transfer of substantially all of the sample fluid from the input well to the storage chamber 140. Another advantage of the hydrophilic coating is that its application to the input well increases the ease with which the sample fluid is released from the fluid introduction means, i.e. the pipette.

It has surprisingly been found that applying a hydrophilic coating results has an advantageous effect on quantification of the sample. Although, albeit at a substantially smaller rate, evaporation still occurs in the storage chamber channel, in devices having a hydrophilic coating in the storage channel, the measured concentration is substantially independent of the amount of sample that was evaporated in the storage chamber channel as long as the remaining sample is sufficient to fill the measurement chamber. The latter allows for accurate quantification, less dependent or independent on the time between input of the sample in the input well and measurement of the sample in the measurement chamber.

As indicated above, the microfluidic device typically may comprise further channels and chambers, such as for example a measurement chamber 150. The measurement chamber may be adapted to the characterisation technique used for characterizing the sample liquid. In one embodiment, the microfluidic device may be adapted for characterisation using absorption measurements, and windows may be provided so that an illumination beam can be guided through the measurement chamber. Other features of the measurement chamber may be as known in the art. Other components in the microfluidic device may be a mixing chamber, a metering or dosing chamber, a reaction chamber, etc. These and other optional features may be as known in the art.

The microfluidic device may be made in any suitable way, such as for example by spray casting, milling, moulding, laminating, sealing with a foil, etc. or a combination thereof. The microfluidic device may be made of any suitable material, such as for example polymers, glass, quartz, silicon, gels, plastics, resins, carbon, metals, etc.

By way of illustration, a number of configurations for the microfluidics devices are illustrated in FIG. 9A to FIG. 9J. FIG. 9A and FIG. 9B illustrate microfluidic devices having an input well 110 with rather steep walls and a flat bottom portion surrounding the throughput opening. In FIG. 9A the cross section of the full storage chamber is equal to the cross-section of the throughput opening. In FIG. 9B, portions of the storage chamber have a larger cross-section than the throughput opening. FIG. 9C and FIG. 9D show similar structures as FIG. 9A and FIG. 9B respectively, but an input well with walls tilted 45° from the normal to the bottom surface of the input well is provided. FIG. 9E and FIG. 9F indicate similar structures as FIG. 9C and FIG. 9D, but without the presence of a flat bottom portion surrounding the throughput opening. FIG. 9G and FIG. 9H show similar structures as FIG. 9E and FIG. 9F, but without the presence of a vertical throughput channel. FIG. 9I and FIG. 9J show similar structures as FIG. 9E and FIG. 9F but part of the upstanding walls are vertically oriented, i.e. parallel with the normal to the plate-shaped portion of the microfluidic device. In these drawings, only a portion of the storage chamber is shown. The storage chamber may become more narrow further downstream (not shown), as discussed above.

In embodiments of the present invention, further measures can be taken to decrease sample evaporation, e.g. sample evaporation in the storage channel, by changing storage temperature and humidity, and/or inhibiting convection of ambient air.

It is an advantage of some embodiments according to the present invention that a number of liquids can be subsequently dispensed in the input well and that these liquids can all be stored in the storage chamber.

Different embodiments for microfluidic devices are described above, providing amongst others the advantage of reducing evaporation of liquid before characterization and consequently improving measurement accuracy.

The solution of using a storage chamber as provided in these embodiments is advantageous over e.g. a solution wherein a hard cover lid or a foil is used to cover the input well, as these latter require additional steps to be performed through human intervention, leading to additional costs and increased risk for errors.

It is an advantage of some embodiments according to the present invention that the use of a storage chamber reduces considerably the evaporation while still allowing a reference measurement. Such reference measurement typically is a blank measurement on an empty measurement chamber allowing to compensate for intrinsic absorption in the microfluidic device. It is an advantage of embodiments according to the present invention that the use of a storage chamber does not hamper the use of a further mixing or reaction chamber.

It is an advantage of embodiments according to the present invention that it does not make use of compensation for evaporation by adding additional sample or solvent, as this may require additional sample fluid andor may influence the analysis results.

It is an advantage of embodiments according to the present invention that substantially all of the liquid received in the input well is spontaneously transferred to the storage chamber allowing characterisation of small amounts of liquids.

Devices and methods according to embodiments of the present invention are especially suitable for performing characterisation by optical absorption measurements.

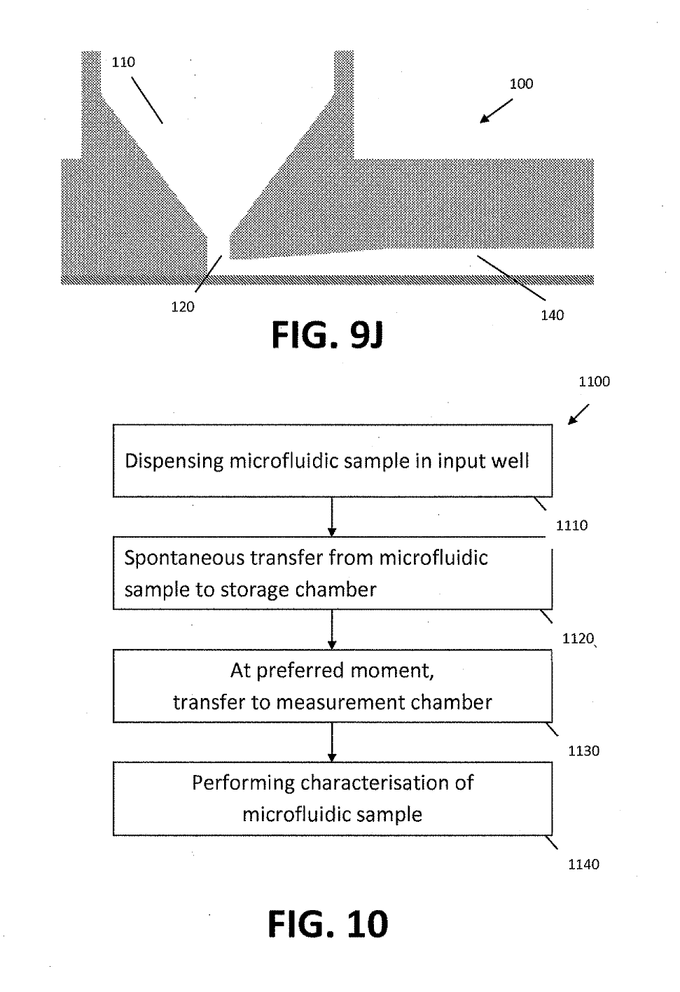

In a further aspect, the present invention also relates to a method for characterizing a microfluidic sample or for assisting therein. The method may be especially suitable for characterizing a microfluidic sample by absorption measurements, although the invention is not limited thereto. The method comprises receiving an amount of liquid to be characterized in the microfluidics device and spontaneously transferring substantially all of said amount of liquid to a storage chamber for storing the liquid prior to said characterisation. In one embodiment, receiving an amount of liquid may be performed by introducing an amount of liquid by releasing the liquid at an upstanding wall of an input well of a characterization device, the upstanding wall extending outside a plate-shaped portion of the characterization device comprising the storage room. By way of illustration, the present invention not being limited thereto, an exemplary method according to an embodiment of this aspect is described and standard and optional steps are shown in FIG. 10. The method 1100 for characterizing a microfluidic sample comprises the step of dispensing 1110 the microfluidic sample to be characterized in an input well of the microfluidic device. The latter is substantially immediately, i.e. within a time span wherein evaporation can be neglected, e.g. a time span of less than 120 seconds, preferably less than 60 seconds, even more preferably less than 30 seconds, spontaneously transferred to a storage chamber in the microfluidic device. The latter may for example be based on capillary forces, although the invention is not limited thereto. The microfluidic sample thus is stored in the storage chamber and can be kept there for a longer period, as substantially less or even no significant evaporation occurs in the storage chamber. At a moment chosen by the user, the microfluidic sample than may be transferred 1130 to the measurement chamber and characterization of the microfluidic sample may be performed 1140. Methods according to embodiments of the present invention furthermore may comprise steps expressing the functionality of the different components or parts thereof of a microfluidic device as described according to the first aspect. Such methods may result in similar advantages.

In still another aspect, the present invention relates to a characterization system for characterising a microfluidic sample, the system comprising a microfluidic device as described in embodiments of the first aspect of the present invention and a detector for detecting a property of the microfluidic sample in a measurement chamber. The system may further comprise conventional and optional components of a microfluidic characterization system as known in the prior art, such as for example a controller, an irradiation source, a pumping unit, a fluid introducing means, a processor, etc.

By way of illustration, embodiments of the present invention not being limited thereto, a set of concentration determination experiments are described. For these experiments a plastic disposable chip with 16 identical structures was used, each containing an inlet suitable for receiving samples up to a few microliter, a hydrophilic capillary channel for storing the sample right after dispensing and two measurement chambers on top of each other suitable for characterizing the samples using optical absorption measurements over an optical path length 0.2 mm and/or over an optical path length of 1 mm (combined 0.2 mm and 0.8 mm).

The chips were suitable for optical absorption measurements in a custom device containing a multi-channel UV-Vis spectrophotometer. Two optical measurements were performed on each sample: a first one with only chamber 1 filled with sample (0.2 mm optical path length), and a second one with both chambers filled (1.0 mm accumulated optical path length).

The experiments were performed on different sample types to illustrate that the results are not limited to a particular class of samples only. In all cases the measured concentrations remain constant within the accuracy range of the optical measurement system despite the slowed down evaporation in the storage chamber that can become substantial after a prolonged time. This illustrates that not only evaporation is reduced by the storage chamber, but also that, surprisingly, in case a hydrophillic coating is used, the remaining evaporation occurring in the storage channel does not influence the measured concentration. In a first set of experiments, a sample comprising ds DNA was tested. The sample comprised 3.0 μL of purified dsDNA (Calf Thymus dsDNA, Invitrogen) solution. Series of 15 identical samples were dispensed in the plastic chips. The 16^{th} sample was a 3.0 uL buffer solution only (no analyte), serving as blank for the other samples. After some time (=residence time) the solution was transported by external pressure to the measurement chambers positioned after the storage channel, where the sample was probed with an optical beam and the concentration was calculated from the absorption spectrum. Experiments were performed for two dsDNA concentration, one with a nominal concentration of approximately 116 ng/uL (concentration C1) and one with a nominal concentration of approximately 492 ng/uL (concentration C2).

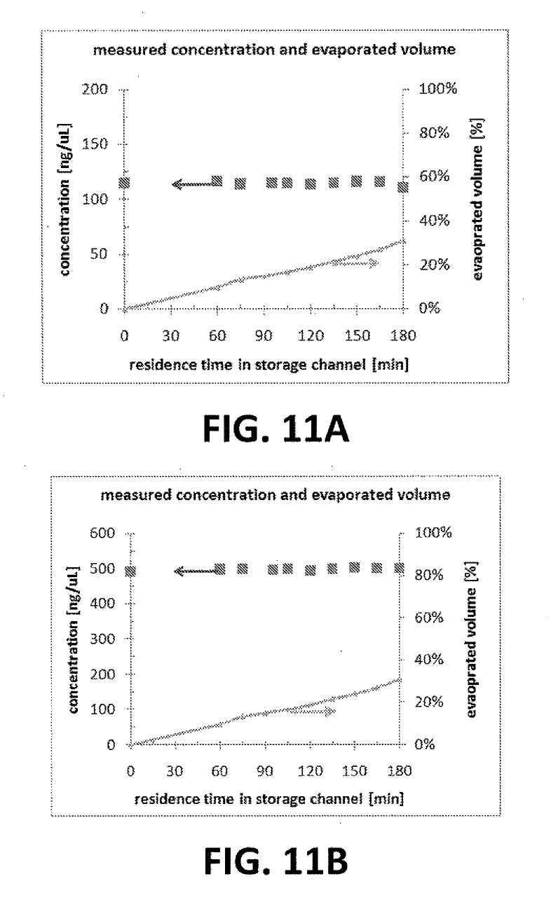

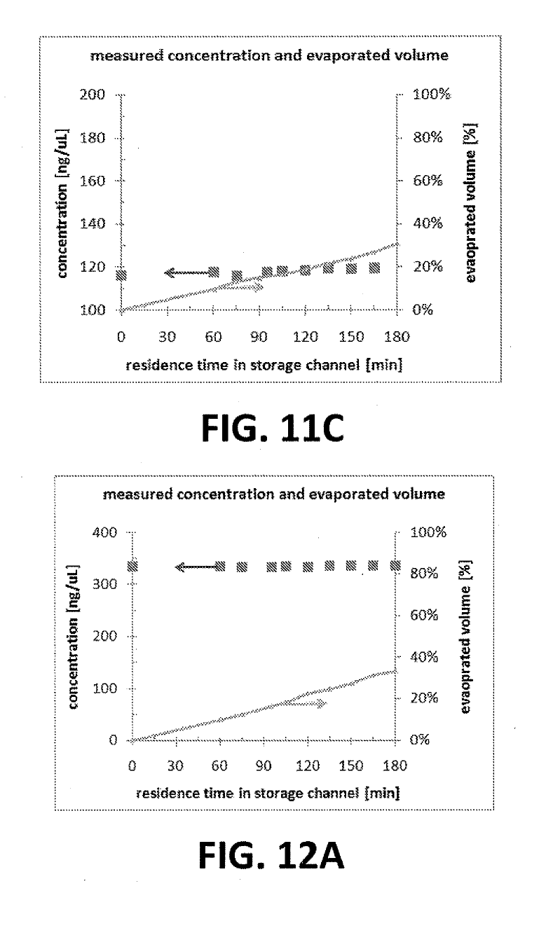

Optical measurements were performed at two distinct path lengths: in the first case a 0.2 mm optical path length (Path length PL1) is realized in single measurement chamber, containing approximately 0.3 uL. In the second case a 1.0 mm optical path length (path length PL2) is realized by two measurement chambers on top of each other, consuming approximately 2.1 uL all together. The evaporation was estimated by analysing the length of the liquid volumes in the storage chamber for different residence times. The depicted evaporated volumes are averaged over both concentrations. FIG. 11A to FIG. 11C illustrate the measured concentration and the evaporated volume as function of the residence time in the storage channel. FIG. 11A and FIG. 11B illustrate the concentration and evaporation behaviour for initial concentrations C1 and C2 respectively for a measurement path length PL1, whereas FIG. 11C illustrate the concentration and evaporation behaviour for initial concentrations C1 for a measurement path length PL2. The transmission for a solution with initial concentration C2 and a measurement path length PL2 was too low to provide accurate information In the graphs each data point represents a chip with 15 identical samples and 1 blank. The depicted concentration is the average of the successful measurements on that same chip. A successful measurement is defined as any measurement that was performed on one or more fully filled measurement chambers. This implicates a minimal amount of sample still being present in the storage channel right before filling the measurement chamber(s). Due to pipetting tolerances (approximately 15% variation) and accuracy of the optical measurement (approximately 1% to 5%, depending on the concentration) some spread can be expected in the results for the individual wells.

From these experiments it can be seen that the measured concentrations remain constant (within the accuracy range of the optical measurement system) for at least 3 hours, while more than 30% of the sample in the hydrophilic storage channel has evaporated within that time. For PL1 all experiments were successful for at least 3 hours as sufficient sample was available to fill the measurement chamber. For PL2 all measurements were successful up to 2 hours. Longer residence times lead to measurement failures as the chambers cannot always be completely filled. The longer the residence time, the more failures occur.

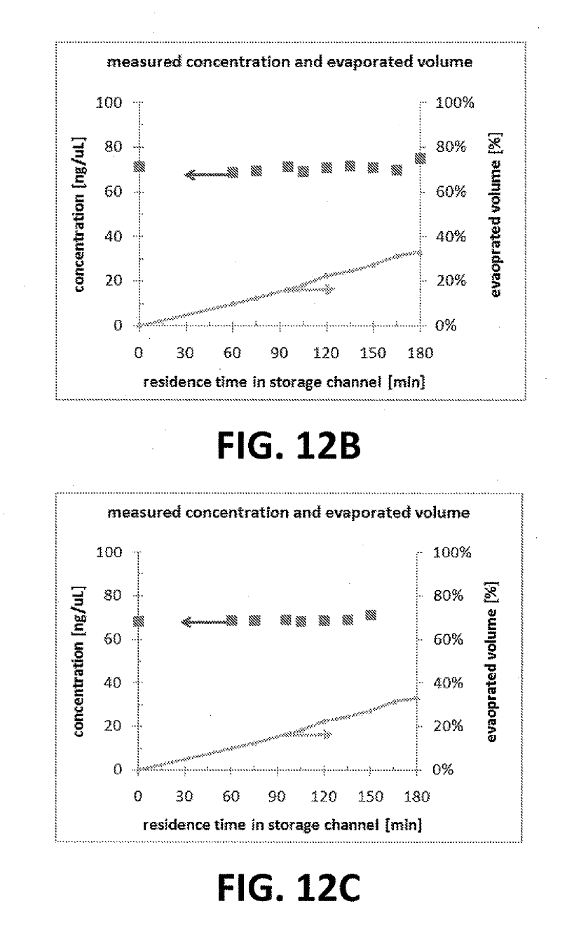

A second set of experiments was performed with a solution of dNTP (deoxyribonucleotide triphosphate, Promega), following a similar procedure as described above. The dNTP samples had a nominal concentration of approximately 68 ng/uL (concentration C1) and 335 ng/uL (concentration C2). FIG. 12A to FIG. 12C illustrate the measured concentration and the evaporated volume as function of the residence time in the storage channel. The depicted evaporated volumes are averaged over both concentrations. FIG. 12A and FIG. 12B illustrate the concentration and evaporation behaviour for initial concentrations C1 and C2 respectively for a measurement path length P11, whereas FIG. 12C illustrate the concentration and evaporation behaviour for initial concentration C1 for a measurement path length P12. The transmission for a solution with initial concentration C2 and a measurement path length PL2 was too low to provide accurate information. Overall, similar conclusions can be drawn as for dsDNA solutions, i.e. while evaporation occurs, this has no influence on the concentration values determined.

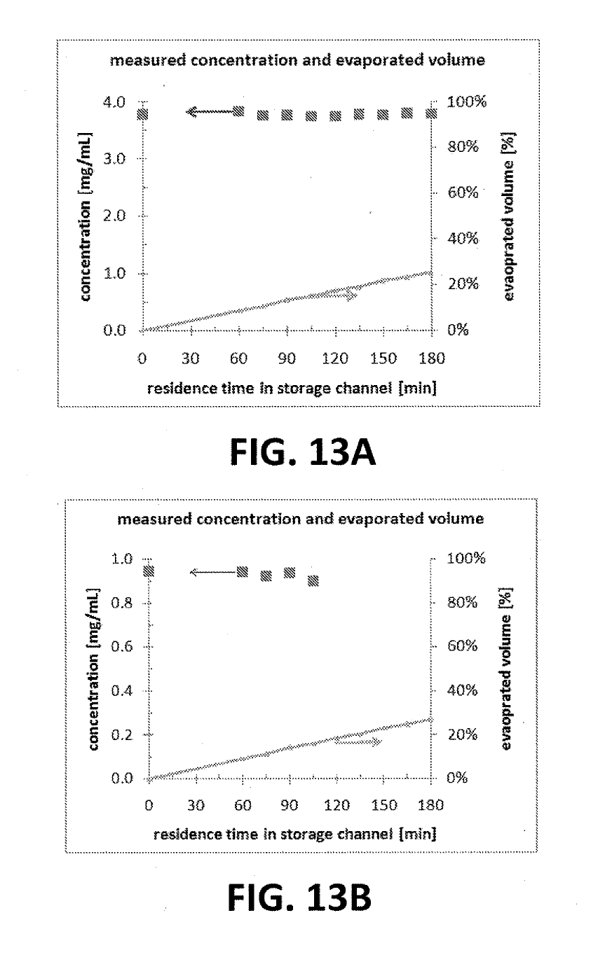

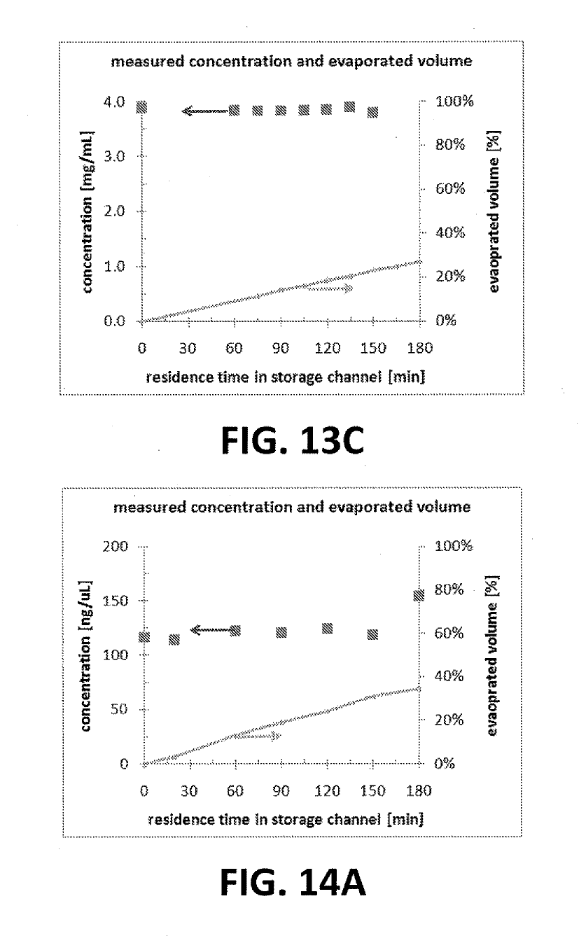

A third set of experiments was performed with a solution of BSA (BSA Fraction V,Invitrogen), following a similar procedure as described above. The BSA samples had a nominal concentration of approximately 0.94 mg/mL (concentration C1) and 3.88 mg/mL (concentration C2). FIG, 13A to FIG. 13C illustrate the measured concentration and the evaporated volume as function of the residence time in the storage channel. The depicted evaporated volumes are averaged over both concentrations. FIG. 13A illustrates the concentration and evaporation behaviour for initial concentration C2 for a measurement path length PL1, whereas FIG. 13B and FIG. 13C illustrate the concentration and evaporation behaviour for initial concentrations C1 and C2 respectively for a measurement path length PL2. The transmission for a solution with initial concentration C1 and a measurement path length PL1 was too high to provide accurate information.

Overall, similar conclusions can be drawn as for dsDNA solutions, i.e. while evaporation occurs, this has no influence on the concentration values determined. The main difference was that all PL2 measurements were successful up to 1.5 hours, then some measurements started to fail due to insufficient sample availability. BSA samples tend to stick more to the pipettor tips at dispensing, and this leads to a reduced dispensing volume in the inlet wells. This observation explains the reduced residence time for a successful measurement.

In yet other experiments a hydrophobic instead of a hydrophilic channel is used. As no capillary forces are present, filling of the channel with sample requires external means in these examples. It has been found that it is not possible to keep the measured concentrations constant within the same period of time.

For these experiments, a system with storage channel as described above was used, wherein the storage channel had hydrophobic walls instead of hydrophilic walls. External pressure was used to push dsDNA samples in the hydrophobic channels.

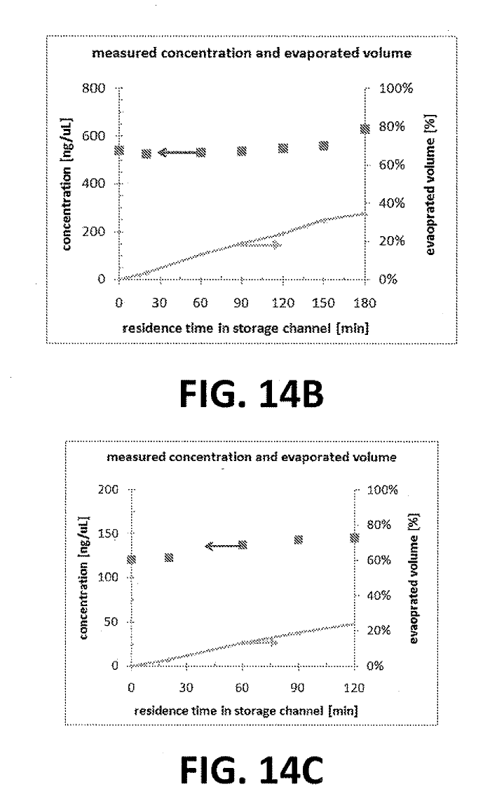

After some time (=residence time) the solution was further transported by external pressure to the measurement chambers right after the storage channel. Again two dsDNA concentrations were measured in this way, with a nominal concentration of approximately 120 ng/uL (concentration C1) and of approximately 540 ng/uL (concentration C2). Also in this case, optical measurements were performed at two distinct path lengths: in the first case a 0.2 mm optical path length (Path length PL1) was realized in single measurement chamber, containing approximately 0.3 uL. In the second case a 1.0 mm optical path length (path length PL2) was realized by two measurement chambers on top of each other, consuming approximately 2.1 μL all together. The evaporation was again estimated by analyzing the length of the liquid volume in the storage chamber for different residence times, FIG. 14A to FIG. 14C illustrate the measured concentration and the evaporated volume as function of the residence time in the storage channel. FIG. 14A and FIG. 14B illustrate the concentration and evaporation behaviour for initial concentrations C1 and C2 respectively for a measurement path length PL1, whereas FIG. 14C illustrates the concentration and evaporation behaviour for initial concentration C1 for a measurement path length PL2. The transmission for initial concentration C2 with a measurement path length of PL2 was too low to provide accurate measurements.

From these experiments it can be seen that, in contrast to use of a hydrophilic coating, the measured concentration will change with the residence time. In case of a measurement at the short path length, only a small portion of the sample in the storage channel is used for the measurement and the measured concentration does not change a lot for a period of 2.5 hours. After that time a substantial increase is measured. When the larger path length is used, more sample from the storage channel is used for filling both measurement chambers. In this case a substantial change in concentration is already observed after 1 hour. Similar as for the above examples, for PL1 all experiments were successful for at least 3 hours as sufficient sample was available to fill the measurement chamber. For PL2 all measurements were successful up to 2 hours. Longer residence times lead to measurement failures as the chambers cannot always be fully filled. The longer the residence time, the more failures occur.

For comparison yet another set of experiments was performed.

In these experiments, a system with storage channel as described above was used, wherein the storage channel had hydrophobic walls instead of hydrophilic walls. This time no external pressure was used to push dsDNA samples in the hydrophobic channels, instead the samples remained in the inlet wells.

After some time (=residence time) the solution was further transported by external pressure to the measurement chambers through the storage channel. Again two dsDNA concentrations were measured in this way, with a nominal concentration of approximately 116 ng/uL (concentration C1) and of approximately 531 ng/uL (concentration C2). Also in this case, optical measurements were performed at two distinct path lengths: in the first case a 0.2 mm optical path length (Path length PL1) was realized in single measurement chamber, containing approximately 0.3 ul. In the second case a 1.0 mm optical path length (path length PL2) was realized by two measurement chambers on top of each other, consuming approximately 2.1 uL all together. This time it was not possible to calculate the evaporated volumes in function of residence times.

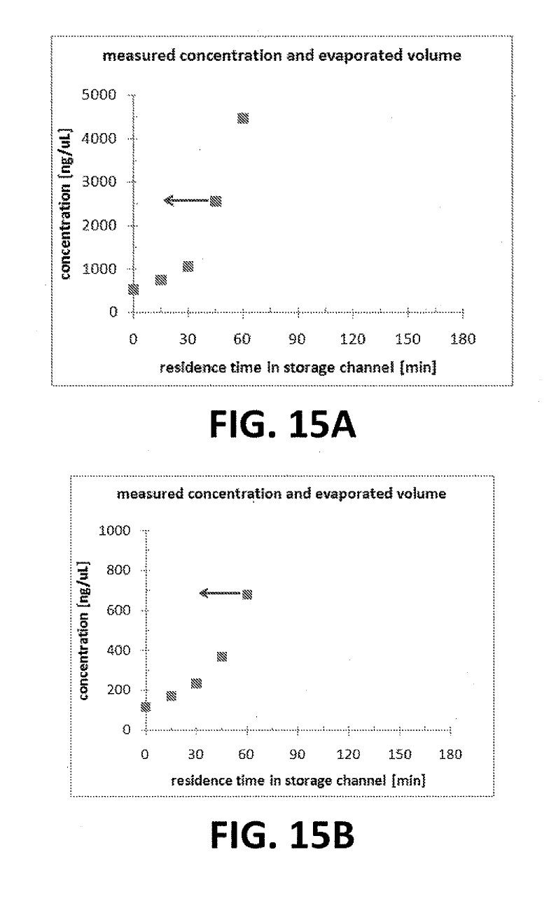

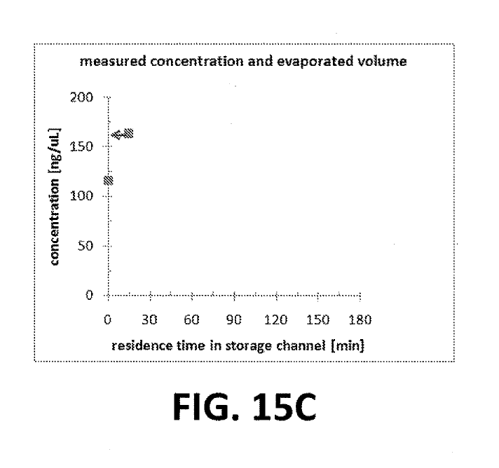

FIG. 15A to FIG. 15C illustrate the measured concentration as function of the residence time in the input well. FIG. 15A and FIG. 15B illustrate the concentration behaviour for initial concentrations C1 and C2 respectively for a measurement path length PL1, whereas FIG. 15C illustrates the concentration behaviour for initial concentration C1 for a measurement path length PL2. The transmission for initial concentration C2 with a measurement path length of PL2 was too low to provide accurate measurements. From these experiments it can be seen that, in contrast to use of a hydrophilic coated storage channel, the measured concentration changes very rapidly with the residence time in the inlet well due to rapid evaporation. Note the reduced time scale in the graphs with respect to the previous experiments.

It was not possible anymore to obtain successful measurements after 1 hour for PL1 and after 15 minutes for PL2 measurements. This clearly demonstrates the reduced evaporation rates that can be obtained in the storage channel.

1-14. (canceled)

15. A microfluidies device comprising
at least one input well for receiving an amount of liquid to be characterized in the microfluidics device,
a storage chamber for storing, prior to said characterisation, the liquid, and
a measurement chamber for receiving said liquid from said storage chamber at a later time for characterization, after said storing,
wherein the storage chamber is a capillary chamber and has a volume arranged to, upon receipt of the amount of liquid in the input well, spontaneously transfer through capillary force substantially all of said amount of liquid to said storage chamber,
the storage chamber being shaped so that the interface area of the liquid with ambient gas directly after filling of the storage chamber is smaller than the interface area of liquid with ambient gas in the input well.

16. The microfluidic device according to claim 15, wherein at least the storage chamber is coated with a hydrophilic coating.

17. The microfluidics device according to claim 15, wherein the storage chamber comprises walls having non-uniform hydrophilic properties.

18. The microfluidic device according to claim 15, wherein the storage chamber has a size for storing at least 80% of the volume of the fluid that can be received in the at least one input well.

19. The microfluidic device according to claim 15, wherein the at least one input well is configured to receive between 0.2 μl and 7 μl of liquid.

20. The microfluidic device according to claim 15, the microfluidic device having a plate-shaped portion comprising the storage room and measurement chamber, wherein the input well has upstanding walls extending outside the plate-shaped portion.

21. The microfluidic device according to claim 15, the at least one input well comprising a plurality of input wells, wherein the microfluidic device is arranged, for each input well, to spontaneously transfer substantially all of said amount of liquid received in the input well to a corresponding storage chamber.

22. The microfluidic device according to claim 15, the microfluidic device being capable to perform optical absorption measurements.

23. The mierofluidics device according to claim 15, the storage chamber comprising a non-constant cross-section.

24. The microfluidics device according to claim 15, the microfluidics device comprising a throughput opening and/or throughput channel connecting the input well to the storage chamber, wherein the throughput opening and/or the throughput channel are hydrophilic.

25. A method for characterizing a microfluidic sample, the method comprising:
receiving an amount of liquid to be characterized in the microfluidics device at an input well,
spontaneously transferring through capillary forces substantially all of said amount of liquid to a storage chamber for storing the liquid prior to said characterization, wherein the interface area of the liquid with ambient gas directly after filling of the storage chamber is smaller than the interface area of liquid with ambient gas in the input well, and
transferring, at a later moment in time after said storing, at least most of the liquid from said storage chamber to a measurement chamber for characterizing the liquid.

26. A method according to claim 25, wherein receiving an amount of liquid comprises introducing an amount of liquid by releasing the liquid at an upstanding wall of an input well of a microfluidic device, the upstanding wall extending outside a plate-shaped portion of the microfluidic device comprising the storage room.

27. A method according to 25, wherein transferring an amount of liquid to the storage channel comprises transferring an amount of liquid to a hydrophilic coated storage channel.

28. A characterization system for characterising a microfluidic sample, the characterization system comprising a microfluidic device as described in claim 15 and a detector for detecting a property of the microfluidic sample in the measurement chamber of the microfluidic device.
